(19) United States
(12) Patent Application Publication
(10) Pub. No.: US 2025/0222378 A1
(43) Pub. Date: Jul. 10, 2025

(54) FILTERING APPARATUS, FILTERING METHOD, AND WATER TREATMENT SYSTEM

(71) Applicants: SUMITOMO ELECTRIC INDUSTRIES, LTD., Osaka-shi, Osaka (JP); NATIONAL UNIVERSITY CORPORATION TOKAI NATIONAL HIGHER EDUCATION AND RESEARCH SYSTEM, Nagoya-shi, Aichi (JP)

(72) Inventors: Shinya UENO, Osaka-shi (JP); Mitsutoshi KAMAKURA, Osaka-shi (JP); Yasuhito MUKAI, Nagoya-shi (JP); Shoji ITO, Nagoya-shi (JP)

(73) Assignees: SUMITOMO ELECTRIC INDUSTRIES, LTD., Osaka-shi, Osaka (JP); NATIONAL UNIVERSITY CORPORATION TOKAI NATIONAL HIGHER EDUCATION AND RESEARCH SYSTEM, Nagoya-shi, Aichi (JP)

(21) Appl. No.: 18/844,637

(22) PCT Filed: Mar. 16, 2023
(86) PCT No.: PCT/JP2023/010368

§ 371 Date: Sep. 6, 2024

(30) Foreign Application Priority Data
Mar. 18, 2022 (JP) 2022-043274

(51) Int. Cl. B01D 33/067; B01D 24/46; B01D 33/46; B01D 33/58; C02F 1/00

(52) U.S. Cl. CPC B01D 33/067; B01D 24/46; B01D 33/463; B01D 33/58; C02F 1/001

(57) ABSTRACT

A filtering apparatus includes a cylindrical filter including a cylindrical screen filter, a treated water nozzle including a nozzle port, a casing where the cylindrical filter is accommodated, the casing containing the nozzle port in the inside, a filtered water flow channel through which filtered water obtained by passage of water to be treated through the screen filter is guided to the outside of the casing, the filtered water flow channel being provided with a flow inlet provided in the inside of the casing, and a rotation mechanism that rotates the cylindrical filter with a central axis of the cylindrical filter. A distance between a centerline of the nozzle port along a direction of outflow of water to be treated and the central axis of the cylindrical filter is shorter than a radius of the cylindrical filter.

### TECHNICAL FIELD

The present disclosure relates to a filtering apparatus, a filtering method, and a water treatment system. The present application claims priority to Japanese Patent Application No. 2022-043274 filed with the Japan Patent Office on Mar. 18, 2022, the entire contents of which are hereby incorporated by reference.

### BACKGROUND ART

For example, Japanese Patent Laying-Open No. 2015-9170 (PTL 1) discloses a cylindrical filter and a ballast water treatment apparatus including the same. For example, a porous structure such as a nonwoven fabric is employed as a material for the cylindrical filter.

### CITATION LIST

### Patent Literature

PTL 1: Japanese Patent Laying-Open No. 2015-9170

### SUMMARY OF INVENTION

A filtering apparatus according to one aspect of the present disclosure includes a cylindrical filter including a cylindrical screen filter made of a woven fabric or a nonwoven fabric, a treated water nozzle including a nozzle port through which water to be treated flows out to a surface of the screen filter, a casing where the cylindrical filter is accommodated, the casing containing the nozzle port in the inside, a filtered water flow channel through which filtered water obtained by passage of water to be treated through the screen filter is guided to the outside of the casing, the filtered water flow channel being provided with a flow inlet provided in the inside of the casing, and a rotation mechanism that rotates the cylindrical filter with a central axis of the cylindrical filter being defined as a center. A distance between a centerline of the nozzle port along a direction of outflow of water to be treated and the central axis of the cylindrical filter is shorter than a radius of the cylindrical filter.

A water treatment system according to one aspect of the present disclosure is a water treatment system including the filtering apparatus described above.

A filtering method according to one aspect of the present disclosure is a filtering method of filtering water to be treated by a cylindrical filter including a cylindrical screen filter made of a woven fabric or a nonwoven fabric. The filtering method includes rotating the cylindrical filter and causing water to be treated to flow out of a nozzle port of a treated water nozzle such that water to be treated passes through the screen filter. The causing water to be treated to flow out includes causing water to be treated to flow out in such a direction that a distance between a centerline of the nozzle port along a direction of outflow of water to be treated and a central axis of the cylindrical filter is shorter than a radius of the cylindrical filter.

### BRIEF DESCRIPTION OF DRAWINGS

FIG. 1 is a schematic diagram schematically showing a filtering method according to an embodiment of the present disclosure.

FIG. 2 is a diagram for illustrating a mechanism of filtering of water to be treated with the filtering method according to the embodiment of the present disclosure.

FIG. 3 is a schematic diagram for illustrating cleaning of a filter by filtering treatment according to the embodiment of the present disclosure.

FIG. 4 is a schematic cross-sectional view showing overview of a construction of a filtering apparatus according to the embodiment of the present disclosure.

FIG. 5 is a diagram illustrating an effect obtained by the filtering method according to one embodiment of the present disclosure.

FIG. 6 is a diagram showing the entire cylindrical filter (filter cartridge) according to one embodiment of the present disclosure.

FIG. 7 is a diagram showing a construction of the cylindrical filter shown in FIG. 6.

FIG. 8 is an exploded view of a filter main body.

FIG. 9 is a partial assembly diagram showing assembly of an upper portion of the cylindrical filter (filter cartridge) according to the embodiment of the present disclosure.

FIG. 10 is a partial assembly diagram showing assembly of a lower portion of the cylindrical filter (filter cartridge) according to the embodiment of the present disclosure.

FIG. 11 is a top view and a side view of an upper lid body of the cylindrical filter (filter cartridge) according to the embodiment of the present disclosure.

FIG. 12 is a schematic diagram showing coupling between a rotation mechanism and the upper lid body of the cylindrical filter (filter cartridge).

FIG. 13 is a bottom view and a side view of a lower lid body of the cylindrical filter (filter cartridge) according to the embodiment of the present disclosure.

FIG. 14 is a diagram showing another form of the cylindrical filter (filter cartridge) according to the embodiment of the present disclosure.

FIG. 15 is a block diagram schematically showing an exemplary water treatment system including the filtering apparatus according to the embodiment of the present disclosure.

### DETAILED DESCRIPTION

### Problem to be Solved by the Present Disclosure

Depending on water quality, a filter made of a nonwoven fabric is clogged in a short period of time by objects floating in water. Factors for clogging include surface deposition and internal obstruction. Surface deposition refers to such a phenomenon that particles larger than an average pore diameter of a filter are deposited on a surface of the filter and a layer of a lump called a cake is formed. Internal obstruction refers to such a phenomenon that particles smaller than an average pore diameter of a filter remain in the inside of the filter to clog a flow channel.

A cake layer can be removed by cleaning of the surface of the filter with a water flow. There are, however, small projections and recesses in the surface of the filter. Therefore, in cleaning of the surface of the filter, a solid may remain in those small recesses. Therefore, an effect of cleaning of the surface of the filter with a water flow should further be enhanced in order to maintain filtering performance of a filtering apparatus.

An object of the present disclosure is to provide a filtering apparatus capable of continuing filtering treatment while clogging of a filter is suppressed, a filtering method with the use of the filtering apparatus, and a water treatment system including the filtering apparatus.

### ADVANTAGEOUS EFFECT OF THE PRESENT DISCLOSURE

According to the present disclosure, a filtering apparatus capable of continuing filtering treatment while clogging of a filter is suppressed, a filtering method with the use of the filtering apparatus, and a water treatment system including the filtering apparatus can be provided.

### DESCRIPTION OF EMBODIMENT OF THE PRESENT DISCLOSURE

Manners in which the present disclosure is carried out will initially be listed and described.
(1) A filtering apparatus according to one aspect of the present disclosure includes a cylindrical filter including a cylindrical screen filter made of a woven fabric or a nonwoven fabric, a treated water nozzle including a nozzle port through which water to be treated flows out to a surface of the screen filter, a casing where the cylindrical filter is accommodated, the casing containing the nozzle port in the inside, a filtered water flow channel through which filtered water obtained by passage of water to be treated through the screen filter is guided to the outside of the casing, the filtered water flow channel being provided with a flow inlet provided in the inside of the casing, and a rotation mechanism that rotates the cylindrical filter with a central axis of the cylindrical filter being defined as a center. A distance between a centerline of the nozzle port along a direction of outflow of water to be treated and the central axis of the cylindrical filter is shorter than a radius of the cylindrical filter.

According to the above, the filtering apparatus capable of continuing filtering treatment while clogging of the filter is suppressed can be realized. The cylindrical filter is formed from a screen filter made of a woven fabric or a nonwoven fabric having a thickness, for example, not larger than 200 μm. Since the screen filter has a small thickness, internal obstruction is less likely. Therefore, a main factor for clogging of the screen filter is surface deposition. The nozzle port is directed to the surface of the screen filter such that the distance between the centerline of the nozzle port along the direction of outflow of water to be treated and the central axis of the cylindrical filter is smaller than the radius of the cylindrical filter. A solid (cake layer) deposited on the screen filter can be removed by a water pressure of water to be treated that flows out of the nozzle port. Furthermore, small recesses located in the vicinity of the surface of the screen filter can also be cleaned by a jet of water to be treated. Therefore, filtering treatment can continue while clogging of the filter is suppressed. The “woven fabric” refers to a fabric, for example, formed by weaving resin fibers or metallic wires, and a material therefor is not particularly limited.
(2) In the filtration apparatus in (1), an angle formed by the centerline of the nozzle port with respect to a tangent of the cylindrical filter at an intersection between the centerline of the nozzle port and a surface of the cylindrical filter is equal to or larger than 1° and equal to or smaller than 45°.

According to the above, water to be treated is incident obliquely to the tangent of the cylindrical filter. Since the pressure of water to be treated applied to the surface of the screen filter can be increased, not only the solid deposited on the screen filter can be removed but also small recesses located in the vicinity of the surface of the screen filter can be cleaned.
(3) In the filtration apparatus in (2), the angle is equal to or larger than 5° and equal to or smaller than 15°.

According to the above, an effect of cleaning of the surface of the screen filter with water to be treated can be enhanced.
(4) In the filtration apparatus in any one of (1) to (3), the cylindrical filter includes a cylindrical filter support including a surface in contact with an inner circumferential surface of the screen filter, the filter support having a plurality of holes provided in the surface, a strut arranged in the inside of the filter support, the strut extending along a direction of the central axis of the cylindrical filter, a first fixing member arranged at a first end of the filter support to fix the strut at the first end, a second fixing member arranged at a second end of the filter support opposite to the first end to fix the strut at the second end, a first sealing member that seals a gap between the first fixing member and the screen filter on a side of the first end of the filter support, and a second sealing member that seals a gap between the second fixing member and the screen filter on a side of the second end of the filter support. The rotation mechanism includes a coupling portion including a protruding portion. The first fixing member is provided with a recess constructed to receive the protruding portion of the coupling portion. The second fixing member is provided with a through hole for passage of the filtered water flow channel.

According to the above, the screen filter is supported by the filter support. The filter support is fixed by the strut, the first fixing member, and the second fixing member. Furthermore, the gap between the screen filter and the filter support can be sealed with the first sealing member and the second sealing member. The screen filter is thus cylindrically supported. In addition, since the recess in the first fixing member is provided to receive the protruding portion of the coupling portion of the rotation mechanism, the first fixing member and the rotation mechanism can be coupled to each other. Water to be treated can thus be filtered by the screen filter while the cylindrical filter is rotated. Since filtered treated water passes through the holes provided in the filter support, treated water can be taken out of the filtered water flow channel.
(5) A water treatment system according to one aspect of the present disclosure includes the filtering apparatus described in any one of (1) to (4).

According to the above, the filtering apparatus useful for the water treatment system that requires filtering of water to be treated as pre-treatment can be realized. Applications of the water treatment system are not particularly limited.
(6) A filtering method according to one aspect of the present disclosure is a filtering method of filtering water to be treated by a cylindrical filter including a cylindrical screen filter made of a woven fabric or a nonwoven fabric. The filtering method includes rotating the cylindrical filter and causing water to be treated to flow out of a nozzle port of a treated water nozzle such that water to be treated passes through the screen filter. The causing water to be treated to flow out includes causing water to be treated to flow out in such a direction that a distance between a centerline of the nozzle port along a direction of outflow of water to be treated and a central axis of the cylindrical filter is shorter than a radius of the cylindrical filter.

According to the above, the filtering apparatus capable of continuing filtering treatment while clogging of the filter is suppressed can be realized.

### DETAILS OF EMBODIMENT OF THE PRESENT DISCLOSURE

An embodiment of the present disclosure will be described in detail below with reference to the drawings. The same or corresponding elements in the drawings have the same reference characters allotted and description thereof will not be repeated.

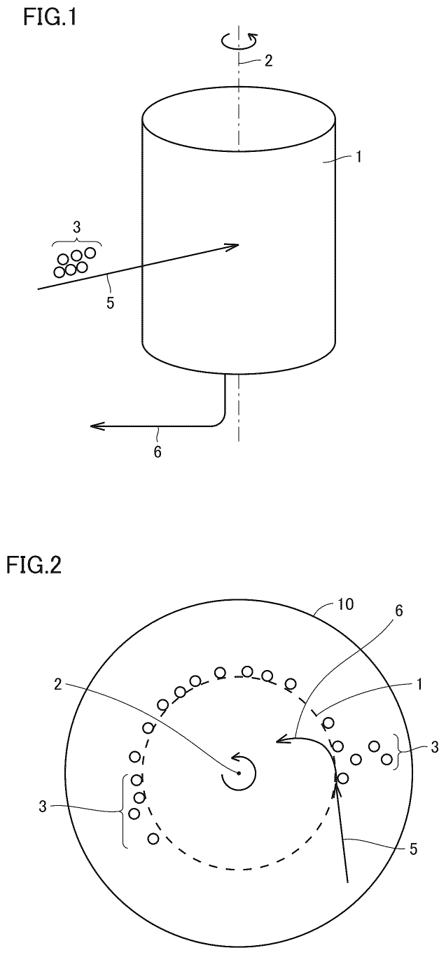

FIG. 1 is a schematic diagram schematically showing a filtering method according to an embodiment of the present disclosure. FIG. 2 is a diagram for illustrating a mechanism of filtering of water to be treated with the filtering method according to the embodiment of the present disclosure.

As shown in FIGS. 1 and 2, in the filtering method according to the embodiment of the present disclosure, a cylindrical filter 1 is used to filter water to be treated 5 to produce filtered water. As shown in FIG. 2, cylindrical filter 1 is accommodated in a casing 10.

Cylindrical filter 1 is a filter obtained by forming a screen filter in a cylindrical shape. In this embodiment, a woven fabric or a nonwoven fabric having a thickness, for example, not larger than 200 μm is employed as the screen filter. A type of yarns to be used for the woven fabric is not particularly limited, and metallic (for example, SUS) wires or resin fibers may be applicable.

The nonwoven fabric is a sheet obtained by intertwining fibers, rather than weaving fibers. The nonwoven fabric is defined, for example, under JIS L0222. A type of resin fibers to be used for the nonwoven fabric is not particularly limited.

As water to be treated 5 passes through cylindrical filter 1, a separation target 3 is removed from water to be treated 5 and filtered water is obtained. Separation target 3, on the other hand, adheres to a surface of cylindrical filter 1. In the embodiment of the present disclosure, while cylindrical filter 1 rotates around a central axis 2 of the cylinder, water to be treated 5 flows toward the surface of cylindrical filter 1 (cylinder). In addition to rotation of cylindrical filter 1, a flow of water to be treated 5 toward the surface of cylindrical filter 1 (cylinder) can remove separation target 3 from the surface of cylindrical filter 1. Therefore, formation of the cake layer at the surface of cylindrical filter 1 can be prevented. As shown in FIGS. 1 and 2, an orientation of rotation of cylindrical filter 1 is the same as an orientation of the flow of water to be treated 5.

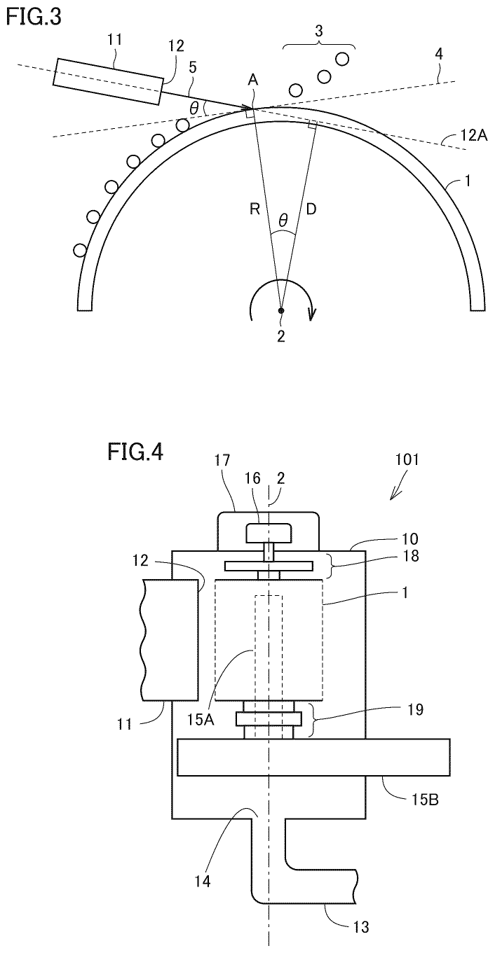

FIG. 3 is a schematic diagram for illustrating cleaning of the filter by filtering treatment according to the embodiment of the present disclosure. As shown in FIG. 3, water to be treated 5 gushes out from a treated water nozzle 11. Treated water nozzle 11 is provided with a nozzle port 12 (opening) directed to cylindrical filter 1 (screen filter).

In FIG. 3, a centerline 12A represents a centerline of nozzle port 12 along a direction of outflow of water to be treated 5. Centerline 12A intersects with the surface of cylindrical filter 1 (screen filter) at a point A. A tangent 4 is a virtual plane in contact with the surface of cylindrical filter 1 (screen filter) at point A.

A radius of curvature of cylindrical filter 1 (screen filter) is denoted as R. Radius of curvature R is equal to a distance from central axis 2 of cylindrical filter 1 to tangent 4. In other words, R represents a length of a normal from central axis 2 of the cylinder to tangent 4. This normal intersects with tangent 4 at point A. Furthermore, a distance between centerline 12A of nozzle port 12 and central axis 2 of cylindrical filter 1 is denoted as D.

In the embodiment of the present disclosure, distance D is shorter than radius of curvature R of cylindrical filter 1. In other words, relation of D<R is satisfied. As nozzle port 12 is directed toward the surface of cylindrical filter 1 so as to satisfy relation of D<R, a water pressure of water to be treated 5 that flows out of nozzle port 12 can remove a solid (cake layer) deposited on the screen filter. Furthermore, small recesses located in the vicinity of the surface of the screen filter can also be cleaned with a jet of water to be treated 5. Therefore, filtering treatment can continue while clogging of the filter is suppressed.

A condition of D<R described above can also be explained with reference to an angle θ between centerline 12A of nozzle port 12 and tangent 4. Angle θ is equal to an angle between the normal from central axis 2 of cylindrical filter 1 to tangent 4 (a line segment that connects central axis 2 and point A to each other) and a line segment that connects central axis 2 of cylindrical filter 1 and centerline 12A of nozzle port 12 to each other.

In the embodiment of the present disclosure, angle θ is larger than 0°. Preferably, angle θ is equal to or larger than 1° and equal to or smaller than 45°. With angle θ being equal to or larger than 1°, in addition to the effect of removal of a solid (cake layer) by a jet of water to be treated 5, the effect of cleaning of small recesses located in the vicinity of the surface of the screen filter can also be obtained. With a larger angle θ, on the other hand, a jet of water to be treated 5 may interfere with rotation of cylindrical filter 1. With angle θ being equal to or smaller than 45°, while interference with rotation of cylindrical filter 1 by a jet of water to be treated 5 is avoided, water to be treated 5 can be filtered and the surface of the screen filter can be cleaned. The effect of cleaning of the surface of the screen filter when angle θ is varied will be described in detail later.

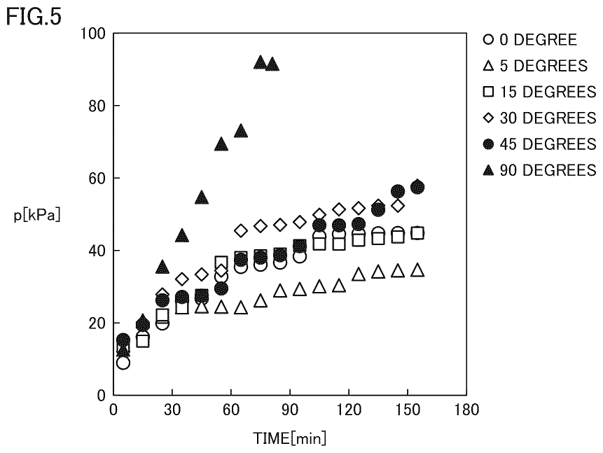

FIG. 4 is a schematic cross-sectional view showing overview of a construction of a filtering apparatus according to the embodiment of the present disclosure. As shown in FIG. 4, a filtering apparatus 101 according to the embodiment of the present disclosure includes cylindrical filter 1, casing 10, treated water nozzle 11, a drain flow channel 13, filtered water flow channels 15A and 15B, a motor 16, a motor cover 17, a coupling portion 18, and a bearing portion 19.

Casing 10 contains therein, nozzle port 12 of treated water nozzle 11, a drain outlet 14 of drain flow channel 13, and filtered water flow channels 15A and 15B, and cylindrical filter 1 and motor 16 are accommodated in casing 10. Casing 10 may be formed as being integrated with treated water nozzle 11, drain flow channel 13, and filtered water flow channels 15A and 15B.

Cylindrical filter 1 is a filter in a cylindrical shape which includes a woven fabric or a nonwoven fabric having a thickness, for example, not larger than 200 μm as the screen filter. Treated water nozzle 11 includes nozzle port 12 through which water to be treated flows out to the surface of the cylindrical filter. A height of nozzle port 12 is not particularly limited. In one embodiment, the height of nozzle port 12 may be lower than a height of cylindrical filter 1.

Filtered water flow channels 15A and 15B are flow channels for guiding treated water (filtered water) filtered by cylindrical filter 1 from the inside of casing 10 to the outside of casing 10. Filtered water flow channel 15A passes through the inside of cylindrical filter 1. Therefore, a through hole for passage of filtered water flow channel 15A is provided at a lower end of cylindrical filter 1. Filtered water flow channels 15A and 15B communicate with each other. Filtered water that passes through cylindrical filter 1 is taken into a flow inlet of filtered water flow channel 15A and flows through filtered water flow channel 15A, and is taken out of filtered water flow channel 15B.

Drain flow channel 13 is a flow channel for draining drain water containing a separation target removed by cylindrical filter 1 to the outside of casing 10. Though not shown, a valve may be provided in drain flow channel 13. An amount of treatment by the filtering apparatus can be controlled by control of opening and closing of the valve.

For example, while cylindrical filter 1 filters water to be treated, the valve may be closed. Filtering apparatus 101 can filter water to be treated while it cleans cylindrical filter 1. Since a total amount of water to be treated 5 supplied to filtering apparatus 101 can thus be filtered through filtering apparatus 101, filtered water production capability can be enhanced. After filtering of water to be treated by cylindrical filter 1 ends, the valve is opened. A separation target accumulated in the inside of casing 10 during filtering treatment can thus be ejected through drain flow channel 13 to the outside of filtering apparatus 101. During filtering of water to be treated, the valve may be open. In this case, water to be treated can be filtered while some of water to be treated that flows in is drained.

Motor 16 rotates cylindrical filter 1 around central axis 2 of the cylinder. In order to obtain desired torque for rotation of cylindrical filter 1, a reduction gear may be combined with motor 16. Motor cover 17 is attached to casing 10 to cover motor 16 (and the reduction gear).

A rotation shaft of motor 16 (a rotation shaft of the reduction gear in an example where motor 16 is coupled to the reduction gear) is coupled to coupling portion 18. At an upper end of cylindrical filter 1, cylindrical filter 1 is coupled to motor 16 (or the reduction gear) with coupling portion 18 being interposed. Thus, as motor 16 rotates, cylindrical filter 1 rotates. Motor 16 (or combination of motor 16 and the reduction gear) and coupling portion 18 correspond to the rotation mechanism for rotation of cylindrical filter 1. On a lower end side of cylindrical filter 1, on the other hand, bearing portion 19 for support of rotating cylindrical filter 1 is provided.

FIG. 5 is a diagram illustrating an effect obtained by the filtering method according to one embodiment of the present disclosure. In a graph shown in FIG. 5, the abscissa represents a duration of filtering treatment with the filtering method according to the embodiment of the present disclosure and the ordinate represents a pressure loss p (unit: kPa) of the cylindrical filter.

The graph in FIG. 5 shows a degree of increase in pressure loss with the duration of filtering treatment when experiments were conducted with the angle (see FIG. 3) between the centerline of nozzle port 12 and the tangent of the filter being varied. A flow rate in supply of water to be treated to the filter was the same regardless of the angle.

As the effect of cleaning of the surface of the filter is greater, progress of clogging of the filter is suppressed and hence the degree of increase in pressure loss is lower. Based on comparison of the degree of increase in pressure loss during the duration of filtering treatment from zero minute to ninety minutes, pressure loss when the angle between the centerline of nozzle port 12 and the tangent is between zero degree and forty-five degrees is smaller than pressure loss when the angle is ninety degrees, and can be suppressed to substantially ½ or lower.

Furthermore, when the angle between the centerline of nozzle port 12 and the tangent of the filter is five degrees, the degree of increase in pressure loss is lower than when the angle is zero degree, fifteen degrees, thirty degrees, and forty-five degrees. This may be because the recesses in the surface of the filter were more effectively cleaned. It was confirmed that, with the longer duration of filtering, the degree of increase in pressure loss when the angle was fifteen degrees was lower than the degree of increase in pressure loss when the angle was thirty degrees and forty-five degrees. This may be because, as the angle is larger, the cake layer at the surface of the filter was removed by water to be treated, however, the effect of cleaning of the recesses in the surface of the filter became weaker. Therefore, the angle between the centerline of nozzle port 12 and the tangent is preferably between more than zero degree (for example, one degree) and forty-five degrees and further preferably between five degrees and fifteen degrees.

In the embodiment of the present disclosure, cylindrical filter 1 can be a cartridge type filter. A replaceable filter can thus be realized.

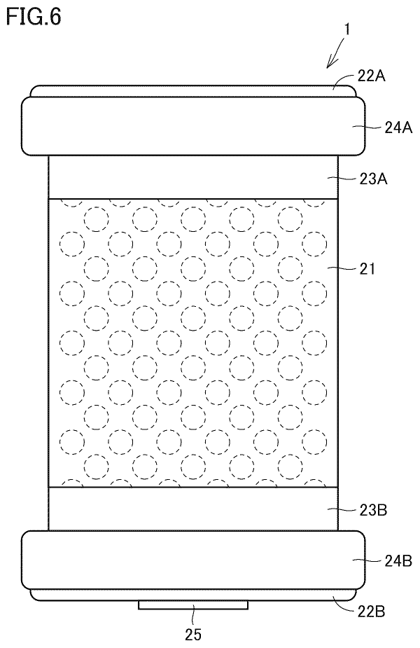

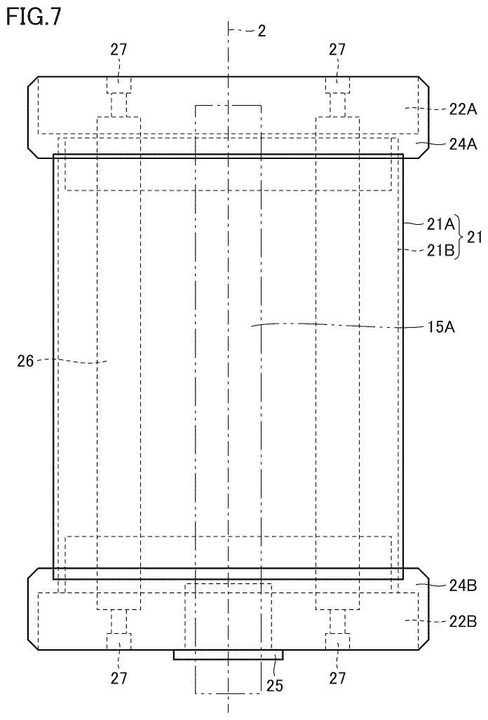

FIG. 6 is a diagram showing the entire cylindrical filter (filter cartridge) according to one embodiment of the present disclosure. FIG. 7 is a diagram showing a construction of the cylindrical filter shown in FIG. 6. As shown in FIGS. 6 and 7, cylindrical filter 1 includes a filter main body 21, lid bodies 22A and 22B, sealing tapes 23A and 23B, sealing members 24A and 24B, a bearing ring 25, a strut 26, and a screw 27. For the sake of convenience of illustration, FIG. 6 does not show strut 26 and screw 27 and FIG. 7 does not show sealing tapes 23A and 23B.

Filter main body 21 includes a screen filter 21A and a cylindrical filter support 21B.

Strut 26 is arranged in the inside of filter support 21B to extend along a direction of central axis 2 of cylindrical filter 1.

Lid body 22A is arranged at a first end (upper end) of filter support 21B to close an opening at the first end. Lid body 22B is arranged at a second end (lower end) of filter support 21B opposite to the first end to close an opening at that end. Strut 26 located on an upper end side of filter support 21B has an end fixed to lid body 22A by screw 27. Similarly, strut 26 located on a lower end side of filter support 21B also has an end fixed to lid body 22B by screw 27. Strut 26 is thus fixed to lid bodies 22A and 22B and filter support 21B is supported by strut 26 and lid bodies 22A and 22B.

Sealing tapes 23A and 23B are wound around the upper end and the lower end of cylindrical screen filter 21A, respectively. Sealing tapes 23A and 23B fix screen filter 21A to filter support 21B and bury a gap between screen filter 21A and filter support 21B.

Sealing member 24A is provided at the upper end of filter support 21B so as to surround sealing tape 23A and lid body 22A. Sealing member 24B is provided at the lower end of filter support 21B so as to surround sealing tape 23B and lid body 22B. Sealing members 24A and 24B seal the gap between screen filter 21A and filter support 21B, together with sealing tapes 23A and 23B. Therefore, in this embodiment, sealing member 24A and sealing tape 23A correspond to the first sealing member that seals the gap between lid body 22A and screen filter 21A on the upper end side of filter support 21B. Similarly, sealing member 24B and sealing tape 23B correspond to the second sealing member that seals the gap between lid body 22B and screen filter 21A on the lower end side of filter support 21B.

A through hole is provided in lid body 22B for passage of filtered water flow channel 15A in the inside of filter support 21B. Bearing ring 25 is inserted in the through hole in lid body 22B. Lid body 22A covers the upper end of filtered water flow channel 15A.

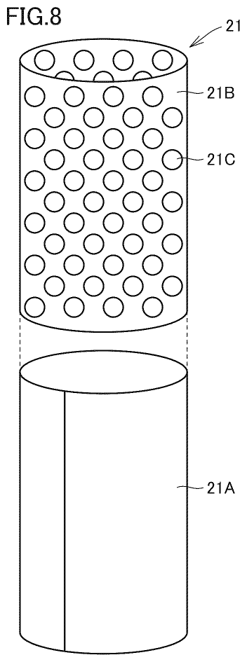

FIG. 8 is an exploded view of filter main body 21. As shown in FIG. 8, filter support 21B is cylindrical. Filter support 21B is provided with a surface where a plurality of holes 21C are provided. By way of example, filter support 21B is formed by working a perforated metallic sheet (which is generally called “punching metal”) into a cylindrical shape.

Screen filter 21A is wound such that the surface of filter support 21B is in contact with an inner circumferential surface of screen filter 21A. Therefore, the cylindrical screen filter is formed.

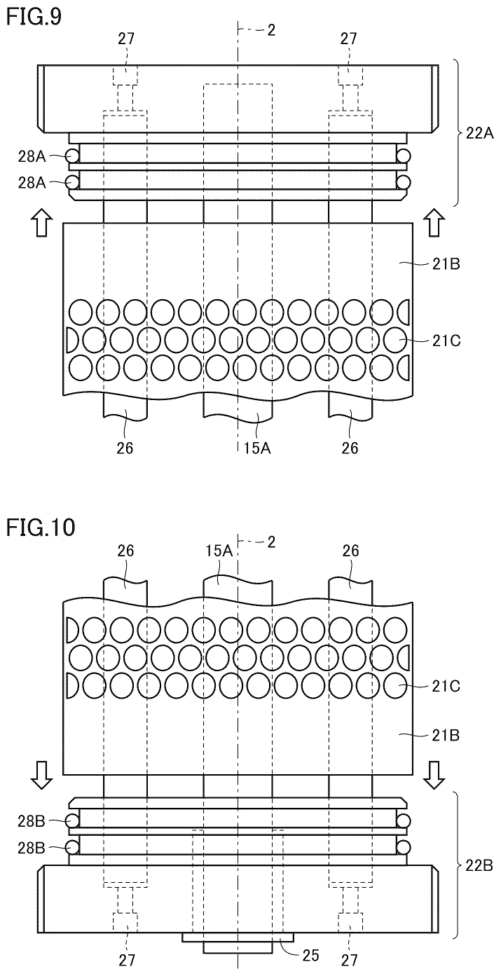

FIG. 9 is a partial assembly diagram showing assembly of an upper portion of the cylindrical filter (filter cartridge) according to the embodiment of the present disclosure. FIG. 9 does not show sealing tape 23A and sealing member 24A shown in FIG. 6. As shown in FIG. 9, the upper end of strut 26 is inserted in lid body 22A and fixed to lid body 22A by screw 27. Furthermore, filtered water flow channel 15A passes through filter support 21B and filter 22A covers a state of filtered water flow channel 15A. In this state, lid body 22A is attached to the upper end of filter support 21B. In order to bury the gap between lid body 22A and filter support 21B, an O ring 28A is attached to lid body 22A.

FIG. 10 is a partial assembly diagram showing assembly of a lower portion of the cylindrical filter (filter cartridge) according to the embodiment of the present disclosure. FIG. 10 does not show sealing tape 23B and sealing member 24B shown in FIG. 6. As shown in FIG. 10, the lower end of strut 26 is inserted in lid body 22B and fixed to lid body 22B by screw 27. Furthermore, bearing ring 25 is inserted in the through hole in lid body 22B. Filtered water flow channel 15A passes through a hollow portion in bearing ring 25 in this state, and lid body 22B is attached to the lower end of filter support 21B. In order to bury the gap between lid body 22B and filter support 21B, an O ring 28B is attached to lid body 22B.

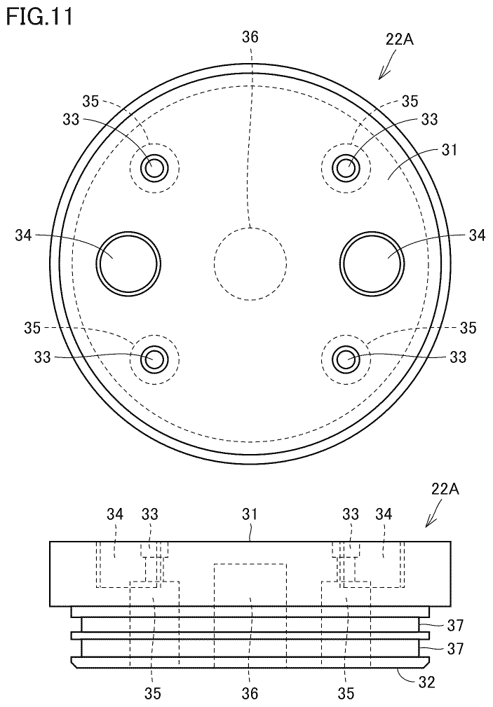

FIG. 11 is a top view and a side view of the upper lid body of the cylindrical filter (filter cartridge) according to the embodiment of the present disclosure. As shown in FIG. 11, lid body 22A is provided with a top surface 31 and a lower surface 32. In top surface 31 of lid body 22A, a plurality of screw holes 33 for passage of screws for fixation of the strut and recesses 34 are provided. In lower surface 32 opposite to top surface 31, a plurality of holes 35 for reception of struts and a hole 36 that receives filtered water flow channel 15A (see FIG. 4) are provided. By fastening screw 27 to strut 26, strut 26 is fixed to lid body 22A (see FIG. 9). Recess 34, however, does not reach lower surface 32 of lid body 22A. Similarly, hole 36 provided in lower surface 32 does not reach top surface 31.

Hole 36 is provided in a central portion of lower surface 32 of lid body 22A. Two recesses 34 are arranged in symmetry with respect to hole 36. Similarly, four holes 35 and four screw holes 33 are arranged in symmetry with respect to hole 36.

Lid body 22A is inserted in the opening at the end (upper end) of filter support 21B to close the end (upper end) of that filter support 21B. A groove 37 is provided in a portion of lid body 22A inserted in the end (upper end) of filter support 21B. In order to enhance hermeticity at the upper end of filter support 21B, O ring 28A may be fitted in groove 37 (see FIG. 9).

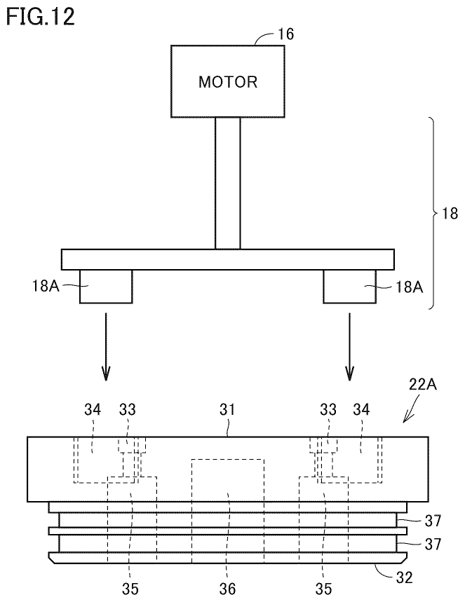

FIG. 12 is a schematic diagram showing coupling between the rotation mechanism and the upper lid body of the cylindrical filter (filter cartridge). As shown in FIG. 12, coupling portion 18 is provided with a protrusion 18A. Recess 34 in lid body 22A is provided in the top surface of lid body 22A to receive protrusion 18A. Lid body 22A and coupling portion 18 are thus coupled to each other.

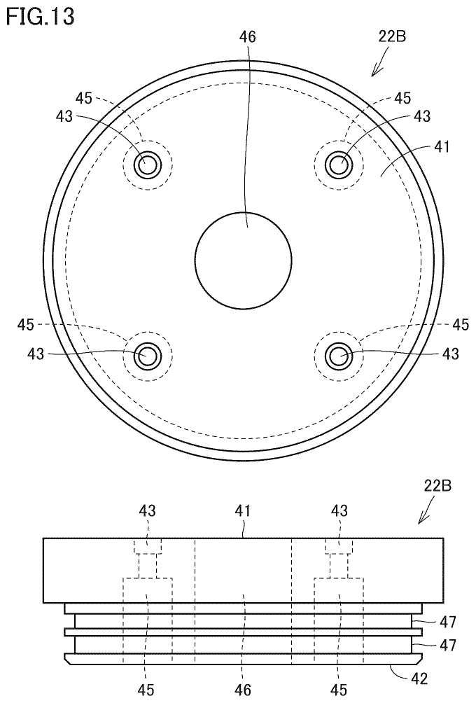

FIG. 13 is a bottom view and a side view of the lower lid body of the cylindrical filter (filter cartridge) according to the embodiment of the present disclosure. As shown in FIG. 13, lid body 22B is provided with a top surface 41 and a lower surface 42. In top surface 41 of lid body 22B, a plurality of screw holes 43 for passage of screws 27 for fixation of struts 26 are provided. In lower surface 42 opposite to top surface 41, a plurality of holes 45 for reception of struts 26 are provided. The plurality of screw holes 43 communicate with respective holes 45 corresponding to screw holes 43. As screw 27 is fastened to strut 26, strut 26 is fixed to lid body 22B (see FIG. 10).

Lid body 22B is inserted in the opening at the end (lower end) of filter support 21B to close the end (lower end) of that filter support 21B. A groove 47 is provided in a portion of lid body 22B inserted in the end (lower end) of filter support 21B. In order to enhance hermeticity at the upper end of filter support 21B, O ring 28B may be fitted in groove 47 (see FIG. 10).

A through hole 46 extending from top surface 41 to lower surface 42 is provided in the central portion of lid body 22B. Through hole 46 is a hole for passage of filtered water flow channel 15A (see FIG. 4). Bearing ring 25 is inserted in through hole 46. Four holes 45 and four screw holes 43 are arranged in symmetry with respect to through hole 46.

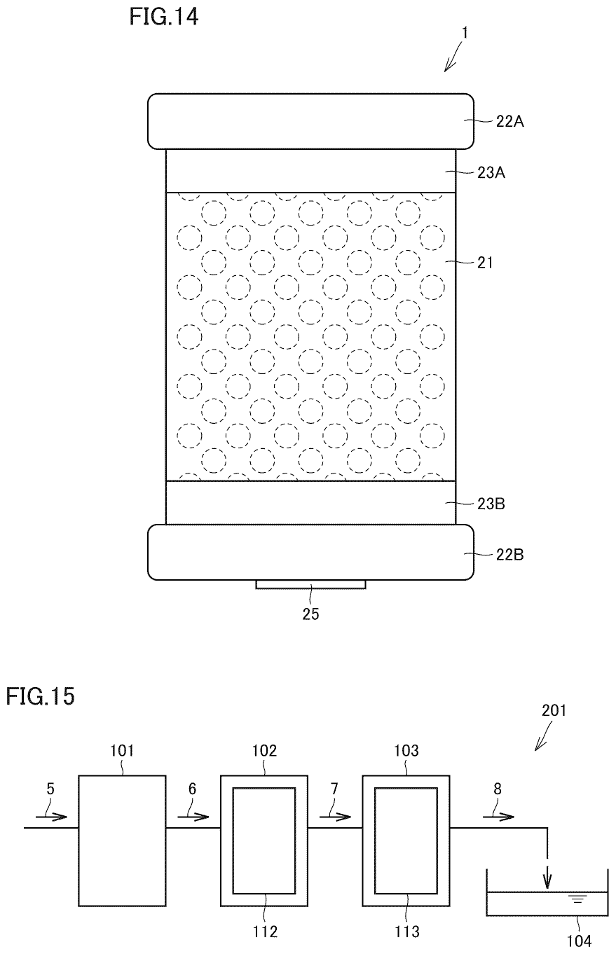

FIG. 14 is a diagram showing another form of the cylindrical filter (filter cartridge) according to the embodiment of the present disclosure. As is understood based on comparison with the construction shown in FIG. 6, in a construction shown in FIG. 14, sealing members 24A and 24B have been omitted from cylindrical filter (filter cartridge) 1. The gap between screen filter 21A and filter support 21B (see FIG. 7) in filter main body 21 may be sealed only with sealing tapes 23A and 23B.

As described above, according to the embodiment of the present disclosure, the filtering apparatus useful for a water treatment system that requires filtering of water to be treated as pre-treatment can be realized. By way of example, the filtering apparatus according to the embodiment of the present disclosure can be applied to a water treatment system. Though a type of the water treatment system including the filtering apparatus according to the embodiment of the present disclosure is not particularly limited, one specific example will be described below.

FIG. 15 is a block diagram schematically showing an exemplary water treatment system including the filtering apparatus according to the embodiment of the present disclosure. Referring to FIG. 15, the water treatment system according to the embodiment of the present disclosure can be realized, for example, as a saline water conversion system 201. Saline water conversion system 201 includes filtering apparatus 101 described above, a filtering apparatus 102 including a filter 112 formed from an ultrafiltration membrane (UF membrane) or a microfiltration membrane (MF membrane), and a reverse osmosis membrane permeation apparatus 103 including a filter 113 formed from a reverse osmosis membrane (RO membrane). A pore diameter of filter 112 is smaller than a pore diameter of cylindrical filter 1 of filtering apparatus 101.

In saline water conversion system 201, filtering apparatus 101 according to the embodiment of the present disclosure is used as a pre-filter and filters water to be treated 5 which is sea water. Filtered water 6 is further filtered by filtering apparatus 102. Filtered water 7 from filtering apparatus 102 is supplied to reverse osmosis membrane permeation apparatus 103. As filtered water 7 passes through filter 113 of reverse osmosis membrane permeation apparatus 103, pure water 8 is produced. Pure water 8 is stored in a tank 104.

It should be understood that the embodiment disclosed herein is illustrative and non-restrictive in every respect. The scope of the present disclosure is defined by the terms of the claims rather than the embodiment above and is intended to include any modifications within the scope and meaning equivalent to the terms of the claims.

### REFERENCE SIGNS LIST

1 cylindrical filter; 2 central axis; 3 separation target; 4 tangent; 5 water to be treated; 6, 7 filtered water; 8 pure water; 10 casing; 11 treated water nozzle; 12 nozzle port; 12A centerline; 13 drain flow channel; 14 drain outlet; 15A, 15B filtered water flow channel; 16 motor; 17 motor cover; 18 coupling portion; 18A protrusion; 19 bearing portion; 21 filter main body; 21A screen filter; 21B filter support; 21C, 35, 36, 45 hole; 22A, 22B lid body; 23A, 23B sealing tape; 24A, 24B sealing member; 25 bearing ring; 26 strut; 27 screw; 28A, 28B ring; 31, 41 top surface; 32, 42 lower surface; 33, 43 screw hole; 34 recess; 37 groove; 46 through hole; 101, 102 filtering apparatus; 103 reverse osmosis membrane permeation apparatus; 104 tank; 112, 113 filter; 201 saline water conversion system; A point; D distance; R radius of curvature.

1. A filtering apparatus comprising:
a cylindrical filter including a cylindrical screen filter made of a woven fabric or a nonwoven fabric;
a treated water nozzle including a nozzle port through which water to be treated flows out to a surface of the screen filter;
a casing where the cylindrical filter is accommodated, the casing containing the nozzle port in inside;
a filtered water flow channel through which filtered water obtained by passage of water to be treated through the screen filter is guided to outside of the casing, the filtered water flow channel being provided with a flow inlet provided in the inside of the casing; and
a rotation mechanism that rotates the cylindrical filter with a central axis of the cylindrical filter being defined as a center, wherein
a distance between a centerline of the nozzle port along a direction of outflow of water to be treated and the central axis of the cylindrical filter is shorter than a radius of the cylindrical filter.

2. The filtering apparatus according to claim 1, wherein
an angle formed by the centerline of the nozzle port with respect to a tangent of the cylindrical filter at an intersection between the centerline of the nozzle port and a surface of the cylindrical filter is equal to or larger than 1° and equal to or smaller than 45°.

3. The filtering apparatus according to claim 2, wherein
the angle is equal to or larger than 5° and equal to or smaller than 15°.

4. The filtering apparatus according to claim 1, wherein
the cylindrical filter includes
a cylindrical filter support including a surface in contact with an inner circumferential surface of the screen filter, the filter support having a plurality of holes provided in the surface,
a strut arranged in inside of the filter support, the strut extending along a direction of the central axis of the cylindrical filter,
a first fixing member arranged at a first end of the filter support to fix the strut at the first end,
a second fixing member arranged at a second end of the filter support opposite to the first end to fix the strut at the second end,
a first sealing member that seals a gap between the first fixing member and the screen filter on a side of the first end of the filter support, and
a second sealing member that seals a gap between the second fixing member and the screen filter on a side of the second end of the filter support,
the rotation mechanism includes a coupling portion including a protruding portion,
the first fixing member is provided with a recess constructed to receive the protruding portion of the coupling portion, and
the second fixing member is provided with a through hole for passage of the filtered water flow channel.

5. A water treatment system comprising the filtering apparatus comprising:
a filtering apparatus, the filtering apparatus comprising:
a cylindrical filter including a cylindrical screen filter made of a woven fabric or a nonwoven fabric;
a treated water nozzle including a nozzle port through which water to be treated flows out to a surface of the screen filter;
a casing where the cylindrical filter is accommodated, the casing containing the nozzle port in inside;
a filtered water flow channel through which filtered water obtained by passage of water to be treated through the screen filter is guided to outside of the casing, the filtered water flow channel being provided with a flow inlet provided in the inside of the casing; and
a rotation mechanism that rotates the cylindrical filter with a central axis of the cylindrical filter being defined as a center, wherein
a distance between a centerline of the nozzle port along a direction of outflow of water to be treated and the central axis of the cylindrical filter is shorter than a radius of the cylindrical filter.

6. A filtering method of filtering water to be treated by a cylindrical filter including a cylindrical screen filter made of a woven fabric or a nonwoven fabric, the filtering method comprising:
rotating the cylindrical filter; and
causing water to be treated to flow out of a nozzle port of a treated water nozzle such that water to be treated passes through the screen filter, wherein
the causing water to be treated to flow out includes causing water to be treated to flow out in such a direction that a distance between a centerline of the nozzle port along a direction of outflow of water to be treated and a central axis of the cylindrical filter is shorter than a radius of the cylindrical filter.
